(19) United States
(12) Patent Application Publication
(10) Pub. No.: US 2019/0146254 A1
(43) Pub. Date: May 16, 2019

(54) IN-CELL TOUCH-SENSITIVE LIQUID CRYSTAL DISPLAY DEVICE

(71) Applicant: Chunghwa Picture Tubes, LTD., Taoyuan City (TW)

(72) Inventor: Jiun-Jr Huang, Yilan County (TW)

(73) Assignee: Chunghwa Picture Tubes, LTD., Taoyuan City (TW)

(21) Appl. No.: 15/844,638

(22) Filed: Dec. 18, 2017

(30) Foreign Application Priority Data
Nov. 10, 2017 (CN) 201711101282.4

(51) Int. Cl. G02F 1/1333; G02F 1/1362; G02F 1/1368; G02F 1/1343; G06F 3/041; G06F 3/044; G02F 1/1335; G02F 1/1339

(52) U.S. Cl. CPC G02F 1/13338; G02F 1/136286; G02F 1/1368; G02F 1/134336; G02F 1/133345; G02F 2201/123; G06F 3/044; G02F 1/133512; G02F 1/13394; G02F 2201/121; G06F 3/0412

(57) ABSTRACT

An in-cell touch-sensitive liquid crystal display device includes: a plurality of gate lines located on a first substrate; a plurality of data lines located on the first substrate and intersecting with the gate lines; a plurality of touch-sensitive signal lines located on the first substrate, wherein each of the touch-sensitive signal lines is located between two adjacent data lines; a plurality of thin-film transistors located on the first substrate and electrically connected to the gate lines and the data lines; a plurality of pixel electrodes electrically connected to the thin-film transistors; a plurality of common electrodes overlapping with the pixel electrodes, wherein the common electrodes are electrically connected to the touch-sensitive signal lines; a first insulating layer located between the common electrodes and the pixel electrodes; a second substrate disposed opposite to the first substrate; and a display medium located between the first substrate and the second substrate.

### CROSS-REFERENCE TO RELATED APPLICATION

This application claims the priority benefit of China application serial no. 201711101282.4, filed on Nov. 10, 2017. The entirety of the above-mentioned patent application is hereby incorporated by reference herein and made a part of this specification.

### BACKGROUND OF THE INVENTION

### Field of the Invention

The disclosure relates to a touch-sensitive liquid crystal display device, and in particular, to an in-cell touch-sensitive liquid crystal display device.

### Description of Related Art

With an advantage of a thin size, the in-cell touch-sensitive display device has been a technical goal for panel manufacturers that intend to enter the field of touch-sensitive products. Through a stack structure where a touch detecting component is embedded in a display panel, the display panel exhibits functions of both image display and touch detection to provide more competitive forms of products.

The current in-cell touch-sensitive display device includes a display panel and a touch detecting component integrated in the display panel. Generally, to integrate the touch detecting component in the display panel, it is required to use an additional mask to form touch-sensitive electrodes and touch-sensitive signal lines. However, such step increases difficulty and costs of the process. Moreover, with the display panel and the touch detecting component integrated with each other, the conductive lines may be excessive and may interfere with each other and affect an aperture ratio. Therefore, how to develop an in-cell touch-sensitive display device that has a simple manufacturing process, incurs low costs, and exhibits excellent performance is one of the goals that people skilled in the art seek to attain.

### SUMMARY OF THE INVENTION

The embodiments of the invention provide an in-cell touch-sensitive liquid crystal display device that incurs low costs and achieves excellent performance.

The in-cell touch-sensitive liquid crystal display device according to an embodiment of the invention includes a first substrate, a plurality of gate lines, a plurality of data lines, a plurality of touch-sensitive signal lines, a plurality of thin-film transistors, a plurality of pixel electrodes, a plurality of common electrodes, a first insulating layer, a second substrate, and a display medium. The gate lines are located on the first substrate. The data lines are located on the first substrate and intersect with the gate lines. The touch-sensitive signal lines are located on the first substrate. Each of the touch-sensitive signal lines is located between two adjacent data lines among the data lines. The thin-film transistors are located on the first substrate and electrically connected to the gate lines and the data lines. The pixel electrodes are electrically connected to the thin-film transistors. The common electrodes are located on the first substrate. One out of the common electrodes and the pixel electrodes has a plurality of slits, and the other one out of the common electrodes and the pixel electrodes overlaps with the slits. The common electrodes overlap with the pixel electrodes. The common electrodes are electrically connected to the touch-sensitive signal lines. The first insulating layer is located between the common electrodes and the pixel electrodes. The second substrate is disposed opposite to the first substrate. The display medium is located between the first substrate and the second substrate.

In the in-cell touch-sensitive liquid crystal display device according to the embodiment of the invention, the first insulating layer covers the pixel electrodes. The common electrodes are located on the first insulating layer. The first insulating layer has a plurality of vias. Each of the common electrodes is electrically connected to at least one corresponding touch-sensitive signal line among the touch-sensitive signal lines through at least one of the vias.

In the in-cell touch-sensitive liquid crystal display device according to the embodiment of the invention, each of the touch-sensitive signal lines includes a trunk portion parallel to the data lines and a contact portion extending outward from the trunk portion. The contact portion of each of the touch-sensitive signal lines overlaps with one corresponding gate line among the gate lines. The at least one via is located on the corresponding gate line. Each of the common electrodes is electrically connected to the contact portion of the at least one corresponding touch-sensitive signal line through the at least one via.

In the in-cell touch-sensitive liquid crystal display device according to the embodiment of the invention, two adjacent thin-film transistors among the thin-film transistors are located on two different sides of a same one data line. The two adjacent thin-film transistors are electrically connected to the same one data line. The two adjacent thin-film transistors are respectively electrically connected to two adjacent gate lines among the gate lines.

In the in-cell touch-sensitive liquid crystal display device according to the embodiment of the invention, the touch-sensitive signal lines and the data lines are disposed in a same layer.

In the in-cell touch-sensitive liquid crystal display device according to the embodiment of the invention, the common electrodes are configured to perform self-capacitance touch sensing.

The in-cell touch-sensitive liquid crystal display device according to the embodiment of the invention further includes a light-blocking pattern layer. The light-blocking pattern layer is located on the common electrodes and has a plurality of openings disposed in correspondence to the pixel electrodes.

The in-cell touch-sensitive liquid crystal display device according to the embodiment of the invention further includes a plurality of spacers. The spacers are disposed on the light-blocking pattern layer.

In the in-cell touch-sensitive liquid crystal display device according to the embodiment of the invention, the spacers overlap with the thin-film transistors.

In the in-cell touch-sensitive liquid crystal display device according to the embodiment of the invention, the light-blocking pattern layer is located between the pixel electrodes and the display medium.

Accordingly, the in-cell touch-sensitive liquid crystal display device of the embodiments of the invention uses a dual-gate design, which thus reduces the number of the data lines to be disposed and the number of source electrode driving chips to be disposed and reduces the costs. Moreover, since the number of the data lines disposed is reduced, the touch-sensitive signal lines can be disposed between two adjacent data lines. In an embodiment of the invention, the touch-sensitive signal lines and the data lines are disposed on the same layer. In other words, the touch-sensitive signal lines and the data lines are optionally manufactured in one process by using the same mask, which thus shortens the process time and reduces the costs.

To provide a further understanding of the aforementioned and other features and advantages of the disclosure, exemplary embodiments, together with the reference drawings, are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A to FIG. 1H are schematic diagrams illustrating a manufacturing process of a pixel array substrate of an in-cell touch-sensitive liquid crystal display device according to an embodiment of the invention.

FIG. 2 is a schematic diagram illustrating a top view of an in-cell touch-sensitive liquid crystal display device according to an embodiment of the invention.

FIG. 3 is a cross-sectional schematic diagram illustrating an in-cell touch-sensitive liquid crystal display device according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

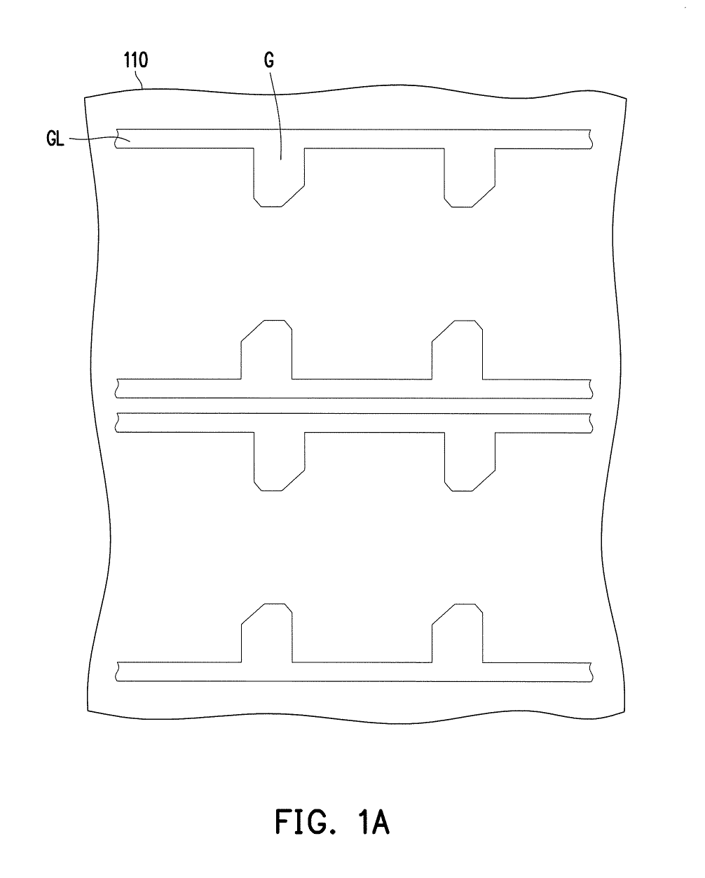

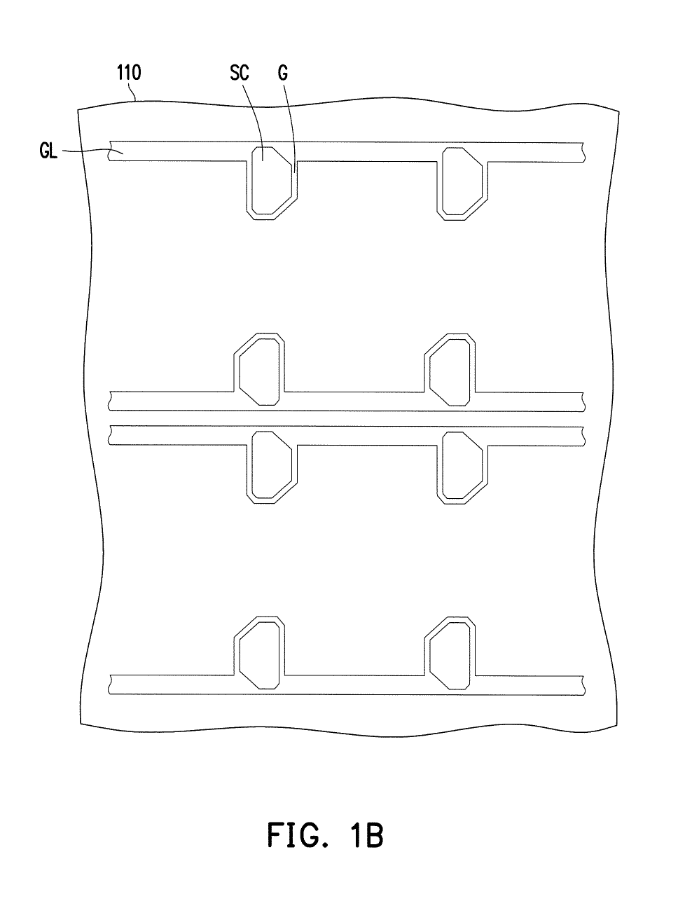

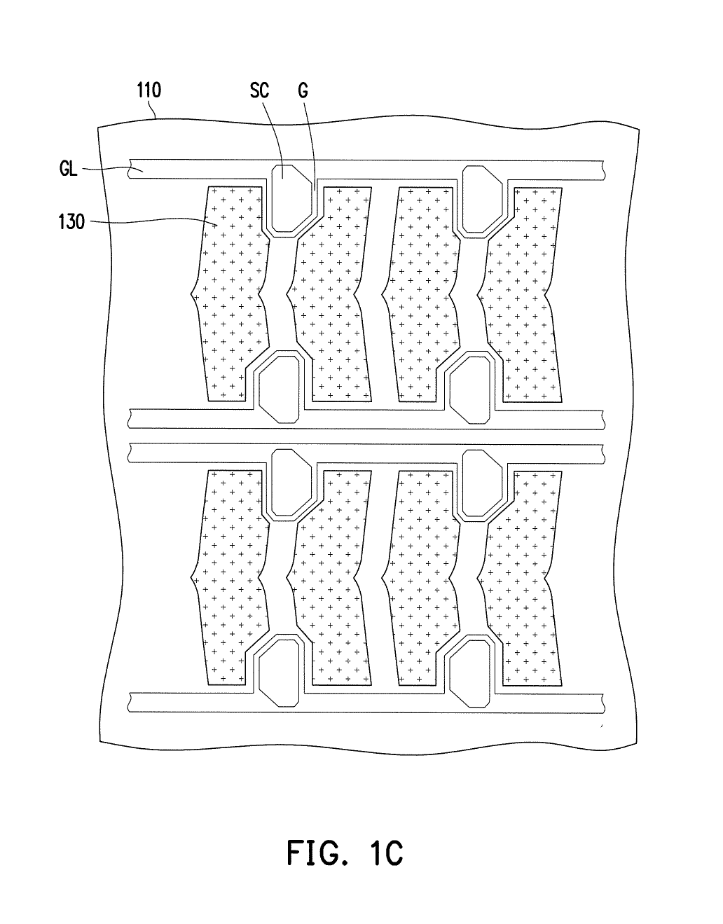

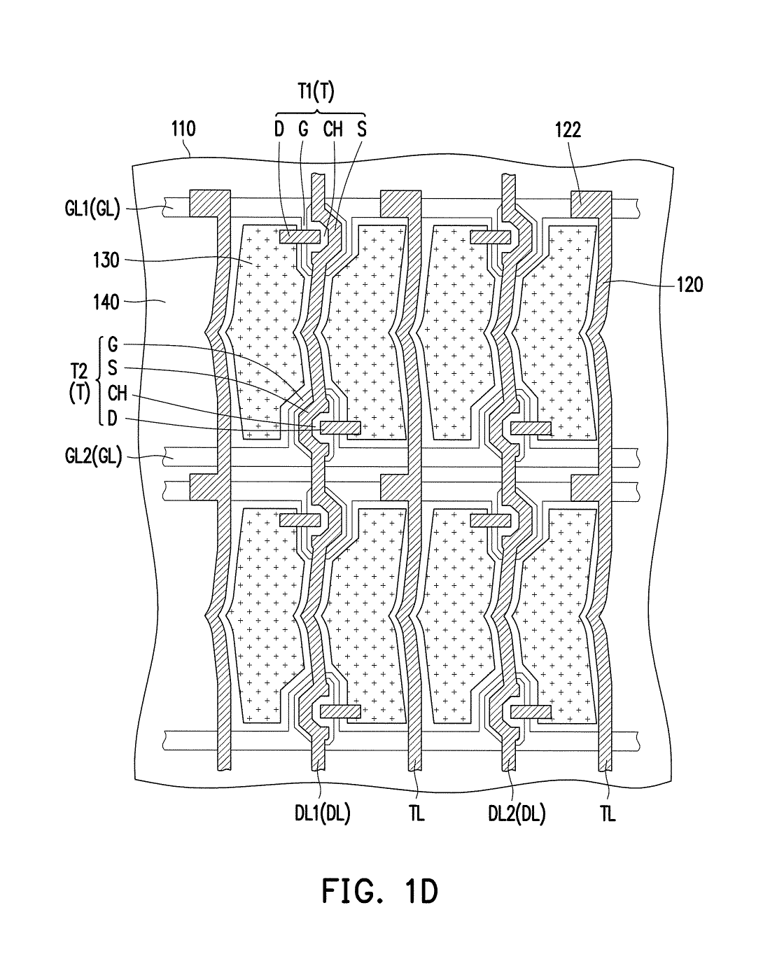

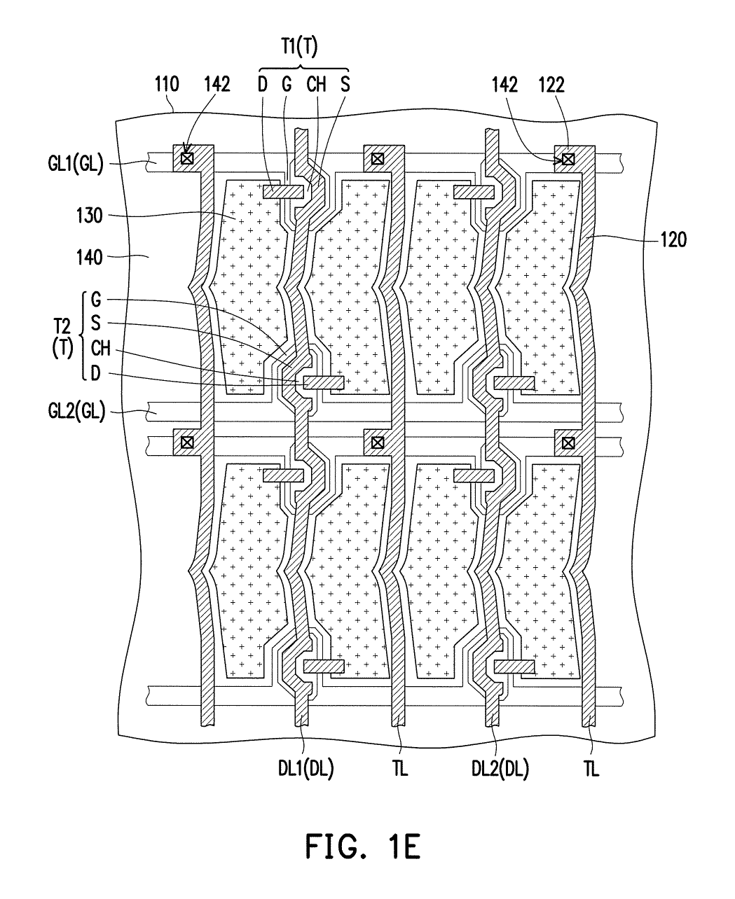

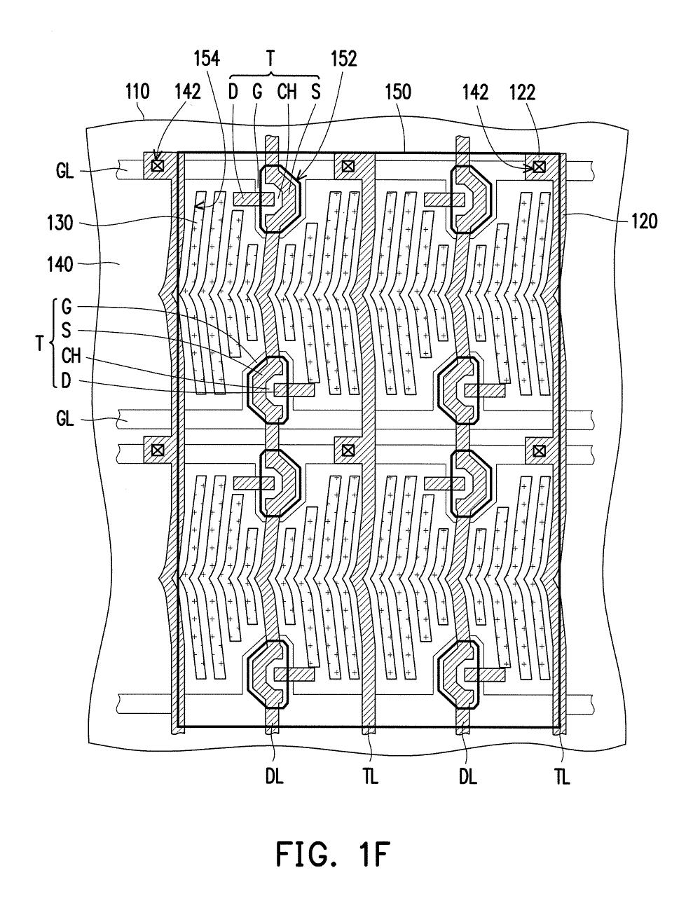

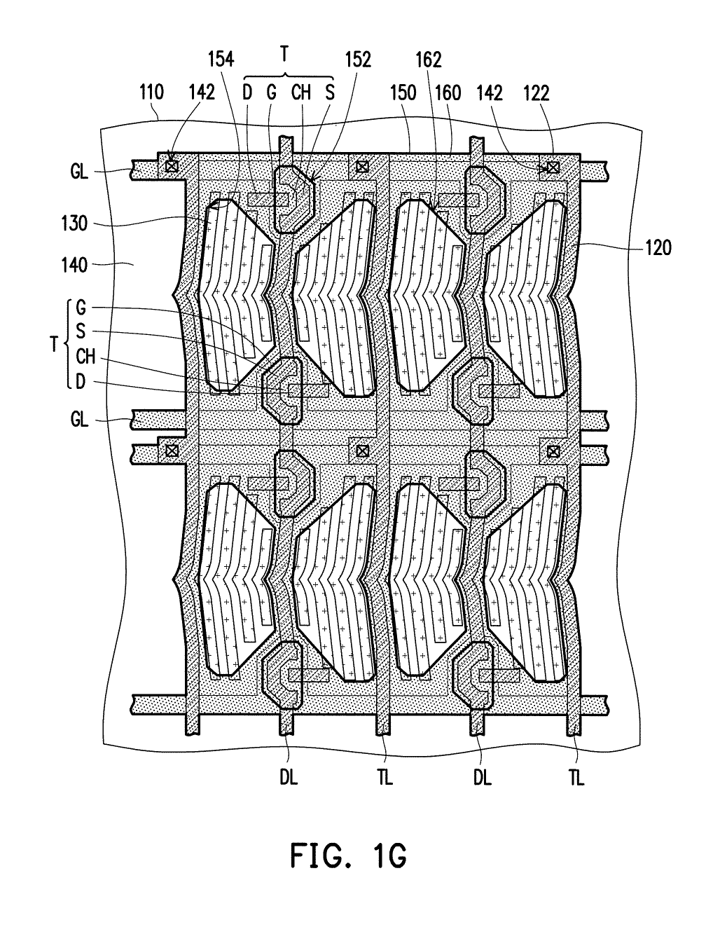

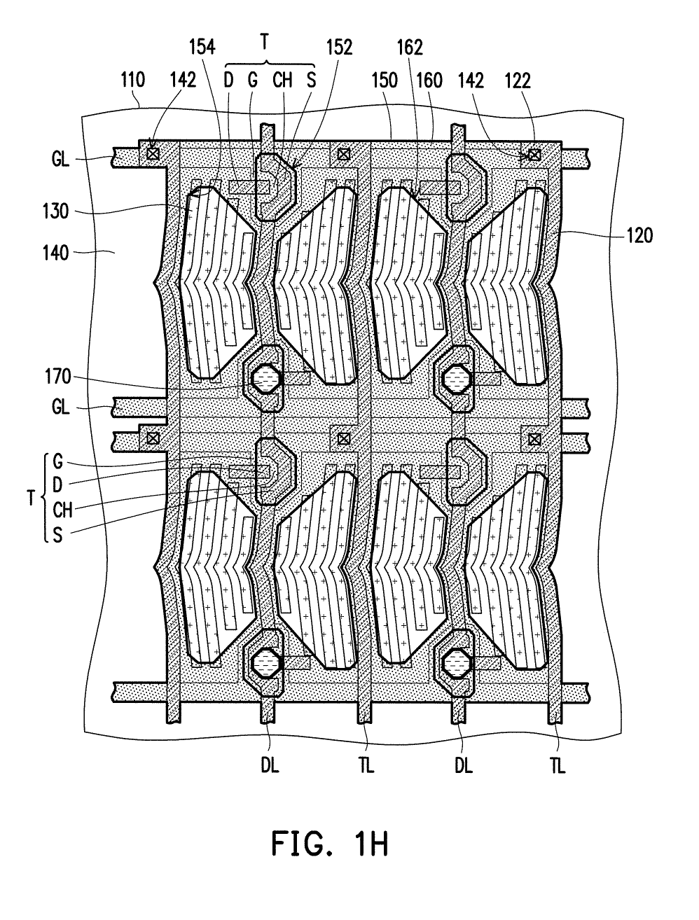

FIG. 1A to FIG. 1H are schematic diagrams illustrating a manufacturing process of a pixel array substrate of an in-cell touch-sensitive liquid crystal display device according to an embodiment of the invention. Referring to FIG. 1A, first, a first substrate 110 is provided. A material of the first substrate 110 is, for example, glass, quartz, an organic polymer, or a non-translucent/reflective material (e.g., a wafer, ceramics, or another suitable material). Then, a first conductive layer (not illustrated) is formed on the first substrate 110 by sputtering, deposition, or another adequate method. Next, the first conductive layer is patterned to form a plurality of gate lines GL and a plurality of gate electrodes G electrically connected to the gate lines GL. In the present embodiment, a material of the gate lines GL and the gate electrodes G is, for example, a metal material or another conductive material, such as an alloy, a nitride of a metal material, an oxide of a metal material, a nitrogen oxide of a metal material, or a stack layer of a metal material and another conductive material.

Referring to FIG. 1A, then, a gate insulating layer (not illustrated) is formed on the first substrate 110. In the present embodiment, the gate insulating layer is formed of, for example, silicon nitride, silicon oxide, or another insulating material. In the present embodiment, the gate insulating layer covers the entire first substrate 110, but the invention is not limited hereto.

Referring to FIG. 1B, next, a plurality of semiconductor patterns SC are formed on the gate insulating layer (not illustrated). Each of the semiconductor patterns SC overlaps with the corresponding gate electrode G. In the present embodiment, a material of the semiconductor patterns SC is selected from, for example, amorphous silicon, polysilicon, microcrystalline silicon, monocrystalline silicon, a metal oxide semiconductor material (e.g., indium-gallium-zinc oxide (IGZO), zinc oxide (ZnO), tin oxide (SnO), indium-zinc oxide (IZO), gallium-zinc oxide (GZO), zinc-tin oxide (ZTO), indium-tin oxide (ITO), etc.), another suitable material, or a combination of the materials above, but the invention is not limited hereto.

Referring to FIG. 1C, then, a plurality of pixel electrodes 130 are formed on the first substrate 110. The pixel electrodes 130 are separate from each other. In the present embodiment, the pixel electrode 130 is, for example, a transparent conductive layer containing a metal oxide such as an indium-tin oxide, an indium-zinc oxide, an aluminum-tin oxide, an aluminum-zinc oxide, an indium-germanium-zinc oxide, another suitable oxide, or a stack layer of at least two of the materials above. However, the invention is not limited hereto. In other embodiments, the pixel electrode 130 may also be a reflective electrode layer or a combination of a reflective electrode layer and a transparent conductive layer.

Referring to FIG. 1D, next, a plurality of data lines DL, source electrodes S, and drain electrodes D, and a plurality of touch-sensitive signal lines TL are formed on the first substrate 110. In the present embodiment, the data lines DL, the source electrodes S, and the drain electrodes D, and the touch-sensitive signal lines TL are simultaneously formed by using the same mask. In other words, the data lines DL, the source electrodes S, the drain electrodes D, and the touch-sensitive signal lines TL are disposed in the same layer. Accordingly, the touch-sensitive signal lines TL are manufactured without using an additional mask, which simplifies the manufacturing process, shortens the manufacturing time, and reduces the manufacturing costs.

Referring to FIG. 1D, the data lines DL intersect with the gate lines GL. The source electrode S and the drain electrode D are respectively electrically connected to two different regions of a channel layer CH. For example, in the present embodiment, the source electrode S is a bent portion of the data line DL, and the bent portion directly covers part of the channel layer CH to be electrically connected to the channel layer CH, but the invention is not limited hereto. One end of the drain electrode D directly covers part of the channel layer CH to be electrically connected to the channel layer CH, and the other end of the drain electrode D directly covers part of the pixel electrode 130 to be electrically connected to the pixel electrode 130, but the invention is not limited hereto. A material of the data lines DL, the source electrodes S, and the drain electrodes D, and the touch-sensitive signal lines TL is, for example, a metal material or another conductive material (e.g., an alloy, a nitride of a metal material, and a nitrogen oxide of a metal material), or a stack layer of a metal material and another conductive material. Specifically, the metal material is, for example, molybdenum (Mo), tungsten (W), aluminum (Al), titanium (Ti), etc., but the invention is not limited hereto.

Referring to FIG. 1D, the gate electrode G, the channel layer CH, the source electrode S, and the drain electrode D form a thin-film transistor T. The thin-film transistor T is located on the first substrate 110. In the present embodiment, two adjacent thin-film transistors T1 and T2 are located on two different sides of the same data line DLL The two adjacent thin-film transistors T1, T2 are electrically connected to the same data line DL1, and the gate electrodes G of the two adjacent thin-film transistors T1, T2 are respectively electrically connected to the adjacent gate line GL1 and gate line GL2. In other words, the in-cell touch-sensitive liquid crystal display device 10 of the present embodiment is a display device using dual-gate driving, which thus reduces the number of the data lines DL to be disposed and further decreases the use of source electrode driving chips (not illustrated) and reduces the costs.

Referring to FIG. 1D, in the present embodiment, the touch-sensitive signal line TL is located between the two adjacent data lines DL1, DL2. The touch-sensitive signal line TL and the data line DL are electrically isolated from the pixel electrode 130. In the present embodiment, the touch-sensitive signal line TL includes a trunk portion 120 and a contact portion 122. The trunk portion 120 is largely parallel to the data lines DL, and the gate lines GL intersect with the trunk portion 120. The contact portion 122 extends outward from the trunk portion 120. As an example, the touch-sensitive signal line TL illustrated in FIG. 1D includes two contact portions 122, but the invention is not limited hereto. The number of the contact portions 122 included in each touch-sensitive signal line TL may be determined according to the actual needs.

Referring to FIG. 1E, then, a first insulating layer 140 is formed on the first substrate 110. The first insulating layer 140 has a plurality of vias 142. In the present embodiment, each of the vias 142 is located above the corresponding gate line GL and exposes part of the touch-sensitive signal line TL. Specifically, in the present embodiment, the vias 142 may overlap with the contact portion 122 of the touch-sensitive signal line TL to expose the contact portion 122 of the touch-sensitive signal line TL. However, the invention is not limited hereto. In other embodiments, the vias 142 may also be disposed at other adequate positions. For example, the vias 142 may also be disposed on a portion of the trunk portion 120 that does not overlap with the gate line GL. Moreover, the invention does not specifically limit the number of the vias 142, and its number may be determined according to the actual needs. A material of the first insulating layer 140 is selected from, for example, an inorganic material, an organic material, another suitable material, or a combination of the materials above. Specifically, the inorganic material is, for example, silicon oxide, silicon nitride, silicon oxynitride, another suitable material, or a stack layer of at least two materials above.

Referring to FIG. 1F, then, a common electrode 150 is formed on the first substrate 110. Specifically, in the present embodiment, the common electrode 150 is formed on the first insulating layer 140. The common electrode 150 is located on the first insulating layer 140 and fills in the vias 142 of the first insulating layer 140 to be electrically connected to the touch-sensitive signal lines TL. In the present embodiment, the common electrode 150 optionally has a plurality of openings 152, and the openings 152 overlap with the channel layers CH. In the present embodiment, a material of the common electrode 150 is, for example, a transparent conductive material such as indium-gallium-zinc oxide (IGZO), zinc oxide (ZnO), tin oxide (SnO), indium-zinc oxide (IZO), gallium-zinc oxide (GZO), zinc-tin oxide (ZTO), indium-tin oxide (ITO), etc. However, the invention is not limited hereto. In other embodiments, the material of the common electrode 150 may also be a reflective conductive material or a combination of a reflective conductive material and a transparent conductive material.

In the present embodiment, the common electrode 150 has a plurality of slits 154, and the pixel electrodes 130 overlap with the slits 154 of the common electrode 150. However, the invention is not limited hereto. In other embodiments, if the common electrode 150 is disposed under the first insulating layer 140, and the pixel electrodes 130 are disposed on the first insulating layer 140, the pixel electrodes 130 instead may have a plurality of slits, and the common electrode 150 overlaps with the slits of the pixel electrodes 130.

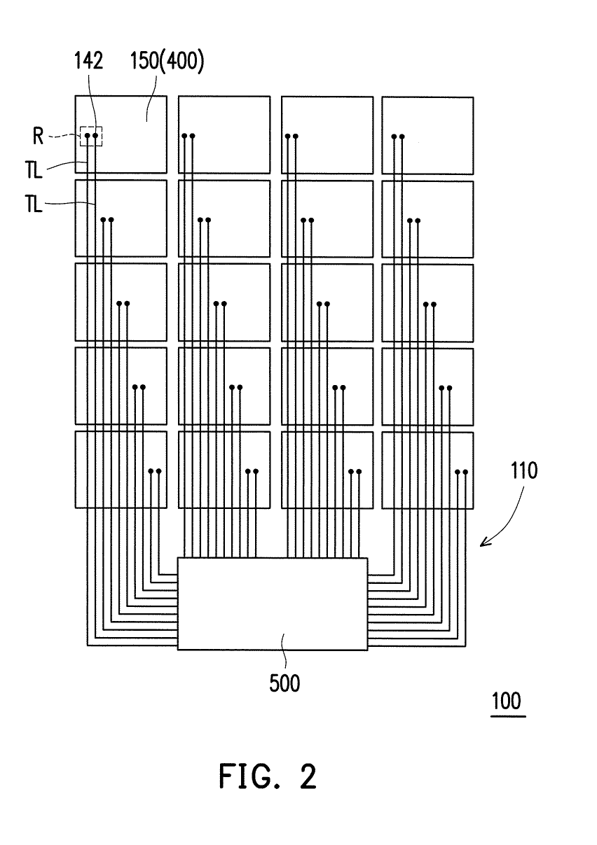

FIG. 2 is a schematic diagram illustrating a top view of an in-cell touch-sensitive liquid crystal display device according to an embodiment of the invention. Referring to FIG. 1F and FIG. 2 at the same time, FIG. 1F may be regarded as an enlarged schematic diagram of a region R in FIG. 2. The common electrode 150 illustrated in FIG. 1F may be equivalent to one common electrode 150 in FIG. 2. The one common electrode 150 is electrically connected to the touch-sensitive signal lines TL through the vias 142. FIG. 2 merely schematically illustrates a plurality of common electrodes 150 of the in-cell touch-sensitive liquid crystal display device 10 respectively electrically connected to a plurality of touch-sensitive signal lines TL. In the present embodiment, each of the common electrodes 150 is electrically connected to two touch-sensitive signal lines TL. However, the invention is not limited hereto. In other embodiments, each of the common electrodes 150 may also be electrically connected to one or three or more touch-sensitive signal lines TL. Moreover, the number of the common electrodes 150 and the touch-sensitive signal lines TL included in the in-cell touch-sensitive liquid crystal display device 10 may be determined according to the actual needs and is not limited to the number of the common electrodes 150 and the touch-sensitive signal lines TL illustrated in FIG. 2.

In the present embodiment, in a touch mode, each of the common electrodes 150 may be regarded as a touch-sensitive electrode 400 for performing touch sensing. More specifically, in the present embodiment, the common electrode 150 is configured to perform self-capacitance touch sensing. In the present embodiment, a plurality of touch-sensitive electrodes 400 are disposed on the first substrate 110, and each of the touch-sensitive electrodes 400 (i.e., each of the common electrodes 150) is electrically connected to at least one corresponding touch-sensitive signal line TL. The touch-sensitive signal lines TL extend outward to be electrically connected to at least one touch controller 500. In the present embodiment, the touch controller 500 is disposed on a periphery of the first substrate 110. However, the invention is not limited hereto. In other embodiments, the touch controller 500 may also be disposed on another component (e.g., an external circuit board outside the in-cell touch-sensitive liquid crystal display device 10.

It is noted that since the common electrode 150 is electrically connected to the corresponding touch-sensitive signal lines TL and can act as the touch-sensitive electrode 400 to perform self-capacitance touch sensing, it is not necessary to additionally form a touch-sensitive electrode in an additional process, thus reducing the number of overall steps for manufacturing the in-cell touch-sensitive liquid crystal display device 10 and further effectively reducing a thickness of the in-cell touch-sensitive liquid crystal display device 10.

Referring to FIG. 1F, in the present embodiment, the first insulating layer 140 covers the pixel electrodes 130, the common electrodes 150 are located on the first insulating layer 140, and the vias 142 of the first insulating layer 140 are located above the gate lines GL. Each of the common electrodes 150 is electrically connected to the contact portions 122 of the touch-sensitive signal lines TL through the vias 142. In other words, the vias 142 of the first insulating layer 140 are disposed above the gate lines GL, which are themselves non-translucent, and the common electrode 150 is electrically connected to the touch-sensitive signal lines TL through the vias 142 disposed above the non-translucent gate lines GL. Therefore, the configuration of the vias 142 does not affect an aperture ratio, and the in-cell touch-sensitive liquid crystal display device 10 exhibits an excellent transmittance.

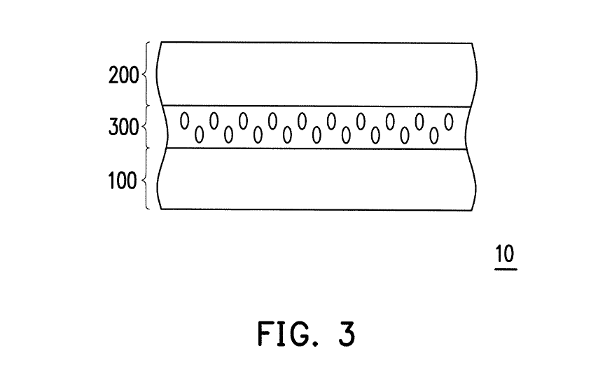

Referring to FIG. 1G, next, in the present embodiment, a light-blocking pattern layer 160 is optionally formed on the common electrode 150. The light-blocking pattern layer 160 is, for example, a black matrix. The light-blocking pattern layer 160 has a plurality of openings 162 disposed in correspondence to the pixel electrodes 130. Each of the openings 162 exposes a portion of the common electrode 150 and a portion of the pixel electrode 130 located below. The light-blocking pattern layer 160 prevents light leakage between the pixel electrodes 130. Referring to FIG. 1H, then, in the present embodiment, a plurality of spacers 170 are optionally formed on the light-blocking pattern layer 160. In the present embodiment, the spacer 170 overlaps with at least one thin-film transistor T. A material of the spacer 170 is, for example, a photoresist but is not limited hereto. Now, the pixel array substrate 100 of the in-cell touch-sensitive liquid crystal display device of the present embodiment is completed. After the pixel array substrate 100, a second substrate 200 (illustrated in FIG. 3), and a display medium 300 (illustrated in FIG. 3) are assembled, the in-cell touch-sensitive liquid crystal display device 10 illustrated in FIG. 3 is formed.

FIG. 3 is a cross-sectional schematic diagram illustrating an in-cell touch-sensitive liquid crystal display device according to an embodiment of the invention. In the present embodiment, an in-cell touch-sensitive liquid crystal display device 10 includes the pixel array substrate 100 described above, a second substrate 200, and a display medium 300. In the present embodiment, the second substrate 200 is disposed opposite to the first substrate 110 (illustrated in FIG. 1H) of the pixel array substrate 100. The display medium 300 is located between the first substrate 110 of the pixel array substrate 100 and the second substrate 200, wherein the light-blocking pattern layer 160 (illustrated in FIG. 1H) of the pixel array substrate 100 is located between the pixel electrodes 130 (illustrated in FIG. 1H) and the display medium 300. In the present embodiment, a material of the second substrate 200 is, for example, glass, quartz, an organic polymer, or another suitable material. The display medium 300 is, for example, liquid crystal molecules.

In summary of the above, the in-cell touch-sensitive liquid crystal display device of the embodiment of the invention includes the common electrodes overlapping with the pixel electrodes, and the common electrode is electrically connected to the touch-sensitive signal lines. The contact portions of the touch-sensitive signal lines are disposed in correspondence to the gate lines. The first insulating layer located between the common electrode and the pixel electrodes has the vias, and the vias are disposed on the gate lines in correspondence to the contact portions. The common electrodes are electrically connected to the touch-sensitive signal lines through the vias.

In the embodiment of the invention, the data lines and the touch-sensitive signal lines are simultaneously formed in one photoetching process by using the same mask without using an additional mask. Moreover, in the embodiment of the invention, two adjacent thin-film transistors are disposed on two sides of the same data line and are connected to the same data line, which reduces the number of the data lines to be disposed and the number of the source electrode driving chips to be disposed and reduces the costs. In addition, the common electrodes are electrically connected to the touch-sensitive signal lines through the vias of the first insulating layer disposed above the gate lines. Therefore, the vias of the first insulating layer do not affect the aperture ratio, and the in-cell touch-sensitive liquid crystal display device exhibits a high transmittance. Furthermore, in the embodiment of the invention, the common electrode is configured to perform self-capacitance touch sensing. Operations of driving and sensing are performed by the common electrode, and it is not necessary to additionally dispose a touch-sensitive electrode, which contributes to reducing the number of steps for manufacturing the in-cell touch-sensitive liquid crystal display device, reducing the thickness of the in-cell touch-sensitive liquid crystal display device, and enhancing the touch sensing effect of the in-cell touch-sensitive liquid crystal display device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An in-cell touch-sensitive liquid crystal display device comprising:
a first substrate;
a plurality of gate lines located on the first substrate;
a plurality of data lines located on the first substrate and intersecting with the gate lines;
a plurality of touch-sensitive signal lines located on the first substrate, wherein each of the touch-sensitive signal lines is located between two adjacent data lines;
a plurality of thin-film transistors located on the first substrate and electrically connected to the gate lines and the data lines;
a plurality of pixel electrodes electrically connected to the thin-film transistors;
a plurality of common electrodes located on the first substrate, wherein one out of the common electrodes and the pixel electrodes has a plurality of slits, the other one out of the common electrodes and the pixel electrodes overlaps with the slits, each of the common electrodes overlaps with the pixel electrodes, and the common electrodes are electrically connected to the touch-sensitive signal lines;
a first insulating layer located between the common electrodes and the pixel electrodes;
a second substrate disposed opposite to the first substrate; and
a display medium located between the first substrate and the second substrate.

2. The in-cell touch-sensitive liquid crystal display device according to claim 1, wherein the first insulating layer covers the pixel electrodes, the common electrodes are located on the first insulating layer, the first insulating layer has a plurality of vias, and each of the common electrodes is electrically connected to at least one corresponding touch-sensitive signal line among the touch-sensitive signal lines through at least one of the vias.

3. The in-cell touch-sensitive liquid crystal display device according to claim 2, wherein each of the touch-sensitive signal lines comprises a trunk portion parallel to the data lines and a contact portion extending outward from the trunk portion, the contact portion of each of the touch-sensitive signal lines overlaps with one corresponding gate line among the gate lines, the at least one via is located on the corresponding gate line, and each of the common electrodes is electrically connected to the contact portion of the at least one corresponding touch-sensitive signal line through the at least one via.

4. The in-cell touch-sensitive liquid crystal display device according to claim 1, wherein two adjacent thin-film transistors among the thin-film transistors are located on two different sides of a same one data line, the two adjacent thin-film transistors are electrically connected to the same one data line, and the two adjacent thin-film transistors are respectively electrically connected to two adjacent gate lines among the gate lines.

5. The in-cell touch-sensitive liquid crystal display device according to claim 1, wherein the touch-sensitive signal lines and the data lines are disposed in a same layer.

6. The in-cell touch-sensitive liquid crystal display device according to claim 1, wherein the common electrodes are configured to perform self-capacitance touch sensing.

7. The in-cell touch-sensitive liquid crystal display device according to claim 1, further comprising:
a light-blocking pattern layer located on the common electrodes and having a plurality of openings disposed in correspondence to the pixel electrodes.

8. The in-cell touch-sensitive liquid crystal display device according to claim 7, further comprising:
a plurality of spacers disposed on the light-blocking pattern layer.

9. The in-cell touch-sensitive liquid crystal display device according to claim 8, wherein the spacers overlap with the thin-film transistors.

10. The in-cell touch-sensitive liquid crystal display device according to claim 7, wherein the light-blocking pattern layer is located between the pixel electrodes and the display medium.
